(19) United States
(12) Patent Application Publication
(10) Pub. No.: US 2019/0062583 A1
(43) Pub. Date: Feb. 28, 2019

(54) PIGMENT COMPOSITE PARTICLE, WEATHER RESISTANT COATING COMPOSITION AND WEATHER RESISTANT STRUCTURE EMPLOYING THE SAME

(71) Applicant: INDUSTRIAL TECHNOLOGY RESEARCH INSTITUTE, Hsinchu (TW)

(72) Inventors: Huai-Kuang FU, Taichung City (TW); Pang-Hung LIU, Hsinchu City (TW); Cheng En WU, New Taipei City (TW); Li Wen CHEN, Taichung City (TW)

(73) Assignee: INDUSTRIAL TECHNOLOGY RESEARCH INSTITUTE, Hsinchu (TW)

(21) Appl. No.: 16/113,716

(22) Filed: Aug. 27, 2018

Related U.S. Application Data
(60) Provisional application No. 62/551,365, filed on Aug. 29, 2017.

(30) Foreign Application Priority Data
Dec. 29, 2017 (TW) 106146489

(51) Int. Cl. C09D 17/00; C09D 133/04; C09D 7/20; C09D 5/00; C09B 5/62; C09B 67/02

(52) U.S. Cl. CPC C09D 17/003; C09D 17/002; C09D 133/04; C09B 67/0097; C09D 5/00; C09B 5/62; C09D 7/20

(57) ABSTRACT

A pigment composite particle is provided. The pigment composite particle is a covalently bonded product of a crosslinking structure having silicon-oxygen bonds and a plurality of organic pigment particles. The plurality of organic pigment particles are dispersed in the crosslinking structure. The chemical structure of the organic pigment particle includes C═O and one or more structures selected from the groups defined in the specification. A weather resistant coating composition and a weather resistant structure employing the same are also provided.

### CROSS REFERENCE TO RELATED APPLICATIONS

This application claims the benefit of U.S. Provisional Application No. 62/551,365, filed on Aug. 29, 2017, the entirety of which is incorporated by reference herein.

The present application is based on, and claims priority from, Taiwan Application Number 106146489, filed on Dec. 29, 2017, the disclosure of which is hereby incorporated by reference herein in its entirety.

### TECHNICAL FIELD

The disclosure relates to a pigment composite particle, a weather resistant coating composition and a weather resistant structure employing the same.

### BACKGROUND

Organic pigments are generally added directly to resin to form coatings. However, after the formed coating film is irradiated with ultraviolet light, the organic pigments in the coating film crack, resulting in poor performance of the coating film. Looking at products (by BASF, Cinic and other companies) that are current commercially available, the ΔE of coating film is greater than 2 after 1000 hours of irradiation by ultraviolet light. The weather resistance is poor.

Therefore, a novel pigment with improved weather resistance is needed.

### SUMMARY

An embodiment of the present disclosure provides a pigment composite particle, which is a covalently bonded product of a crosslinking structure having silicon-oxygen bonds and a plurality of organic pigment particles, and the plurality of organic pigment particles are dispersed in the crosslinking structure. The chemical structure of the organic pigment particle comprises C═O and one or more structures selected from a group consisting of:

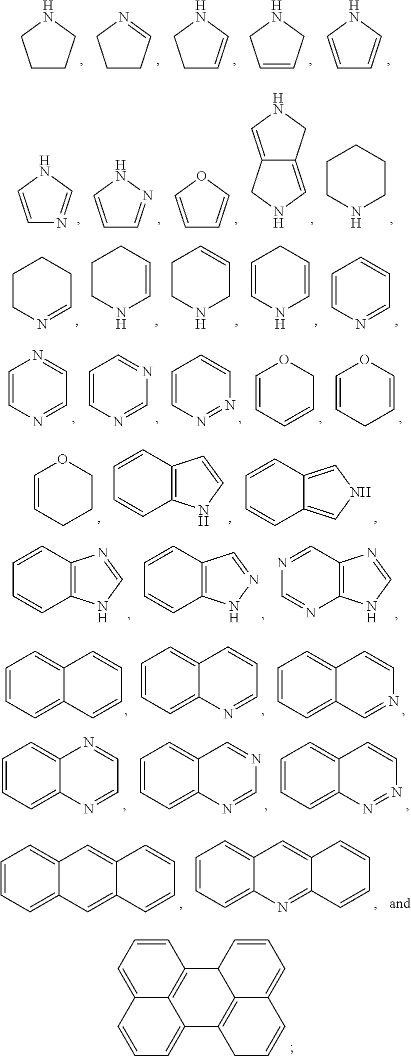

wherein the hydrogen atom on one or more carbons of the above groups is unsubstituted or substituted by halogen atom, CH₃, NH₂, or benzene ring.

Another embodiment of the present disclosure provides a weather resistant coating, including 100 parts by weight of the aforementioned pigment composite particle, 500-1500 parts by weight of a resin, and 100-600 parts by weight of a solvent.

Another embodiment of the present disclosure provides a weather resistant structure, including a substrate, and a weather resistant coating layer disposed on the substrate, wherein the weather resistant coating layer includes 100 parts by weight of the aforementioned pigment composite particle and 500-1500 parts by weight of a resin.

A detailed description is given in the following embodiments with reference to the accompanying drawings.

### BRIEF DESCRIPTION OF DRAWINGS

The present disclosure can be more fully understood by reading the subsequent detailed description and examples with references made to the accompanying drawings, wherein:

FIG. 1 is a schematic cross-sectional view illustrating a pigment composite particle according to an embodiment of the present disclosure;

FIG. 2 is a schematic cross-sectional view illustrating a weather resistant structure according to an embodiment of the present disclosure; and

FIG. 3 is a schematic cross-sectional view illustrating a weather resistant structure according to another embodiment of the present disclosure.

### DETAILED DESCRIPTION

The following provides many different embodiments according to different features of the present disclosure. In the present disclosure, specific components and arrangements are described for simplicity. However, the present disclosure is not limited to these embodiments. For example, the formation of a first component on a second component in the description may include embodiments in which the first and second components are formed in direct contact, and may also include embodiments in which additional components may be formed between the first and second components, such that the first and second components may not be in direct contact. In addition, for the purpose of simplicity and clarity, the present disclosure may repeat reference numerals and/or letters in the various examples. However, it does not in itself dictate a specific relationship between the various embodiments and/or configurations discussed.

As used herein, the singular forms “a,” “an” and “the” are intended to include the plural forms as well, unless the context clearly indicates otherwise. It will be further understood that the terms “comprises” and/or “comprising,”—when used in this specification, specify the presence of stated features, steps, operations, elements, and/or components, but do not preclude the presence or addition of one or more other features, steps, operations, elements, components, and/or groups thereof.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

According to some embodiments, the present disclosure uses a simple sol-gel reaction to modify the organic pigment particles to provide a pigment composite particle having good weather resistance. Coatings and coating structures formed using the pigment composite particles provided by the present disclosure can also have effectively improved weather resistance.

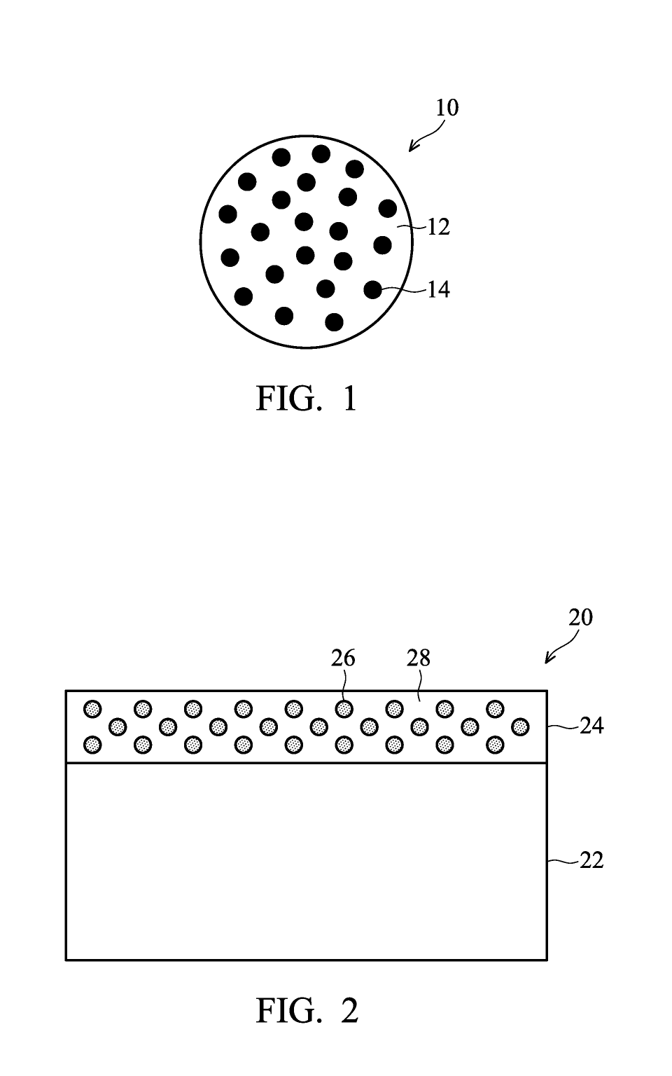

FIG. 1 is a schematic cross-sectional view illustrating a pigment composite particle 10 according to an embodiment of the present disclosure. As shown in FIG. 1, in one embodiment of the present disclosure, a pigment composite particle 10 is provided, which is a covalently bonded product of a crosslinking structure 12 having silicon-oxygen bonds and a plurality of organic pigment particles 14. As shown in FIG. 1, the organic pigment particles 14 are dispersed in the crosslinking structure 12.

It is worth mentioning that, in the pigment composite particle 10 provided by the disclosure, the crosslinking structure 12 having silicon-oxygen (Si—O—Si) bonds is stably bound to the surface of the organic pigment particles 14 through the covalent bond, and provides the organic pigment particles 14 a protective layer, thereby blocking the influence of environmental factors such as sunlight and moisture on the organic pigment particles 14 and effectively delaying the deterioration of the organic pigment particles 14. Therefore, the weather resistance of the pigment composite particle 10 provided by the present disclosure can be effectively improved.

In some embodiments, the chemical structure of the organic pigment particles 14 includes C═O and one or more structures selected from a group consisting of:

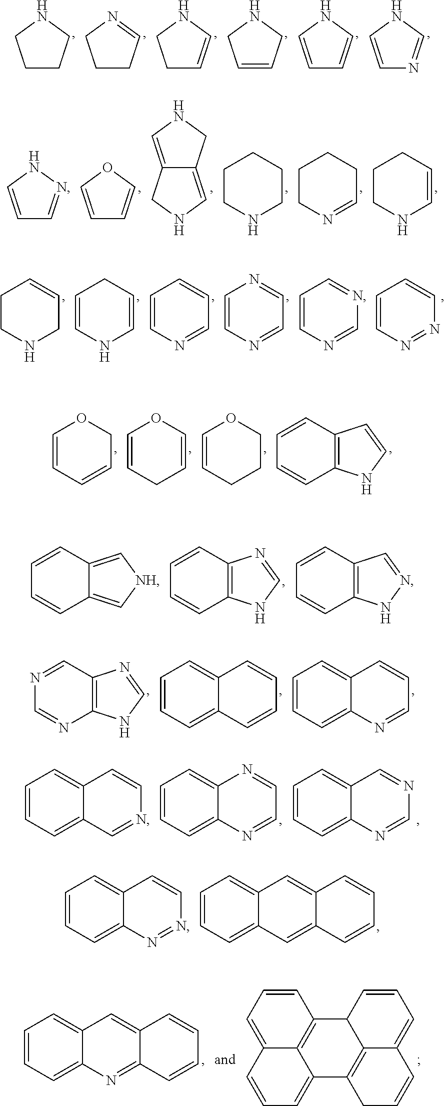

wherein the hydrogen atom on one or more carbons of the above groups is unsubstituted or substituted by halogen atom, CH₃, NH₂, or benzene ring.

In some embodiments, the organic pigment particles 14 used in the present disclosure may include:

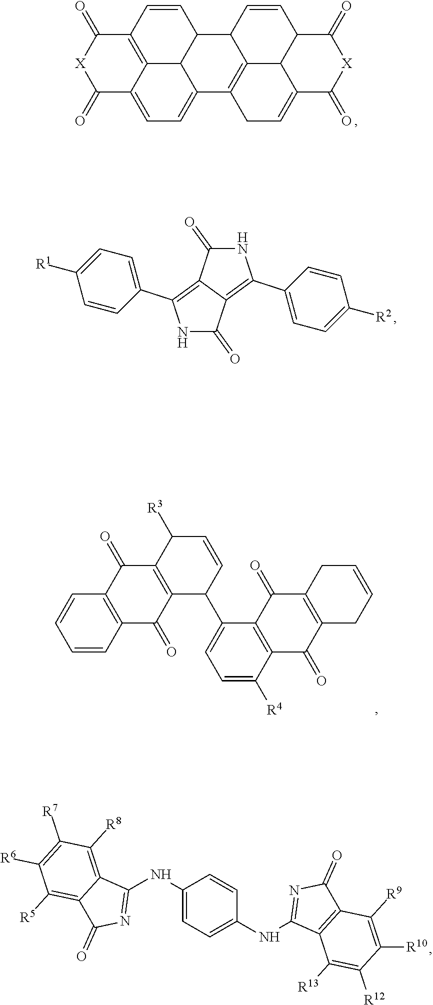

or a combination thereof, wherein X is O, NR, or a combination thereof, R¹ and R² are the same or different and each of R¹ and R² is independently NR, hydrogen atom, halogen atom, hydrocarbon group, benzene ring, or a combination thereof, R³ and R⁴ are the same or different and each of R³ and R⁴ is independently NR, hydrogen atom, halogen atom, hydrocarbon group, benzene ring, or a combination thereof, R⁵ to R¹³ are the same or different and each of R⁵ to R¹³ is independently NR, hydrogen atom, halogen atom, hydrocarbon group, benzene ring, or a combination thereof, wherein R is hydrogen atom, benzene ring, hydrocarbon group, alkylphenyl, or alkylphenyl substituted by alkoxy.

In some embodiments, the organic pigment particles 14 used in the present disclosure may include:

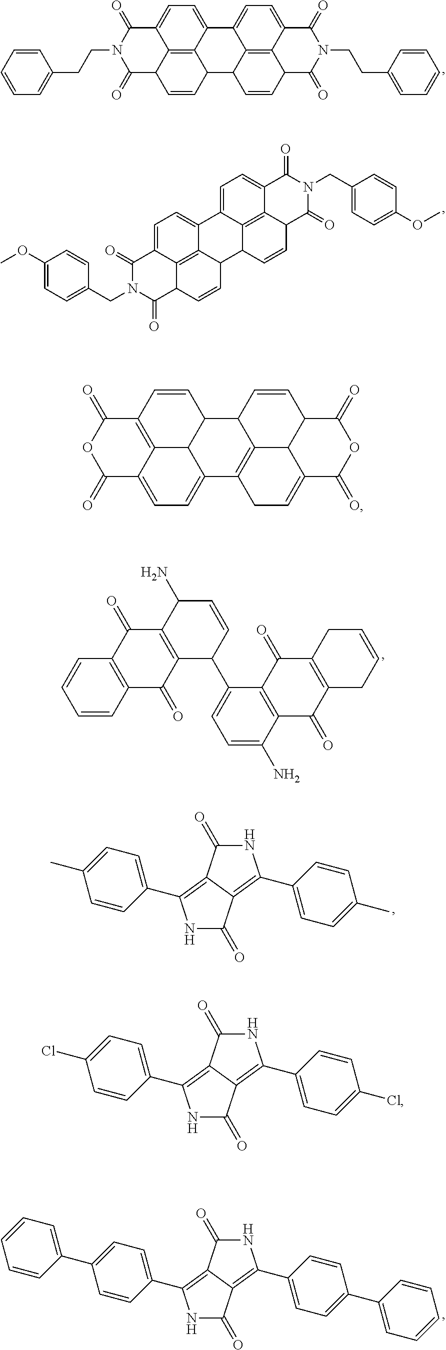

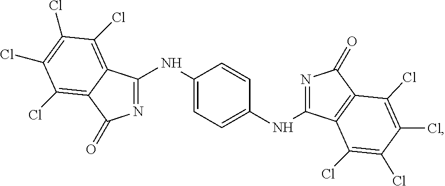 [SMILES: O=C1N=C(Nc2ccc(NC3=NC(=O)c4c(Cl)c(Cl)c(Cl)c(Cl)c43)cc2)c2c(Cl)c(Cl)c(Cl)c(Cl)c21]

or a combination thereof, but is not limited thereto.

It should be noted that the structure of the aforementioned organic pigment particles 14 is only an example and is not intended to limit the disclosure.

In some embodiments, the crosslinking structure 12 having silicon-oxygen bonds is condensated by siloxane compounds having the formula of Si(OR¹)₄ or Si(OR²)₃R³, wherein each of R¹, R², and R³ can be independently H or alkyl group. In some embodiments, the alkyl group may be, for example, C₁-C₈ alkyl group.

In some embodiments, the siloxane compounds may include tetramethoxysilane (TMOS), tetraethoxysilane (TEOS), tetrabutyl orthosilicate (TBOS), methyltriethoxysilane (MTES), n-propyltriethoxysilane, triethoxypentylsilane, isobutyltriethoxysilane, n-octyltriethoxysilane, or a combination thereof. The aforementioned siloxane group can have OH groups after hydrolysis.

In some embodiments, the weight ratio of the crosslinking structure 12 having silicon-oxygen bonds and the organic pigment particles 14 may be, for example, 1:1-3:1.

In some embodiments, the average particle size of the pigment composite particle 10 used in the present disclosure may be, for example, 0.1 μm-50 μm or 1 μm-20 μm. If the average particle size of the pigment composite particle 10 to be used is too large, the resulting coating has poor surface flatness.

The pigment composite particle 10 provided by the present disclosure may be formed by performing a sol-gel method. For example, the reaction may be carried out by first mixing a siloxane compound, organic pigment particles, an acid, and a solvent, and then subjecting the above mixture to a heat treatment to form the pigment composite particles 10 of the present disclosure. For the purpose of explanation, the following description will exemplify specific embodiments, but the disclosure is not limited thereto.

In one embodiment of the present disclosure, tetraethoxysilane (TEOS), organic pigment particles, an acid, and a solvent are mixed and reacted, and then the mixture is subjected to a heat treatment to form pigment composite particles. During the reaction, tetraethoxynonane (TEOS) is first reacted with the acid, so that the four OR groups attached to Si are hydrolyzed into four OH groups. At the time, one of the OH groups will react with the functional group (e.g. C═O) of the organic pigment particles to create a covalent bond. Next, a heat treatment is performed to carry out a condensation reaction between other Si—OH which is not bonded with the organic pigment particles in the siloxane compound, thereby forming a crosslinking structure having Si—O—Si bonds.

After the preparation is completed by the above method, as shown in FIG. 1, in the pigment composite particle 10, the organic pigment particles 14 are dispersed in the crosslinking structure 12 having silicon-oxygen (Si—O—Si) bonds. Also, as described above, the crosslinking structure 12 having Si—O—Si bonds is stably bonded to the surface of the organic pigment particle 14 through a covalent bond. The result is equivalent to forming a protective layer having Si—O—Si bonds on the surface of the organic pigment particle 14. Since the Si—O—Si bond is not easily broken by environmental factors such as sunlight and moisture, the organic pigment particles 14 dispersed in the crosslinking structure 12 can be protected and the deterioration of the organic pigment particles 14 can be delayed.

It is to be understood that in the above sol-gel reaction, the siloxane compound used is not limited to tetraethoxydecane (TEOS) and other suitable siloxane compounds may be included. For example, in one embodiment, the siloxane compound may have the formula of Si(OR¹)₄ or Si(OR²)₃R³, wherein each of R¹, R², R³ may independently be H or alkyl group. In some embodiments, the alkyl group may be, for example, C₁-C₈ alkyl group. In some embodiments, the siloxane compound used in the present disclosure may also be TMOS, TBOS, MTES, n-propyltriethoxysilane, triethoxypentylsilane, isobutyltriethoxysilane, n-octyltriethoxysilane, or a combination thereof. In some embodiments, the siloxane compound used in the present disclosure is TEOS, TMOS, TBOS, or a combination thereof.

In some embodiments, the weight ratio of the siloxane compound and the organic pigment particles 14 may be, for example, 1:1-3:1. For example, in one embodiment of the present disclosure, the weight ratio of the siloxane compound and the organic pigment particles 14 is 2:1. If the weight ratio of the siloxane compound and the organic pigment particles 14 is too large, for example, the ratio value of the siloxane compound to the organic pigment particles 14 is greater than 3, the excess siloxane groups will produce a self-assembly phenomenon, which does not help increase the weather resistance of pigment composite particles, and may cause a premature gelation of the prepared coating, resulting in poor stability of the coating. If the weight ratio of the siloxane compound and the organic pigment particles 14 is too small, for example, when the weight ratio value of the siloxane compound and the organic pigment particles 14 is less than 1, the formed crosslinking structure 12 may not completely coat the organic pigment particles 14, resulting in an insufficient weather resistance.

In some embodiments, the acid used in the sol-gel reaction may include hydrochloric acid, nitric acid, acetic acid, sulfuric acid, or a combination thereof. In the present disclosure, the addition of acid allows hydrolysis of the siloxane compound to produce OH groups. The concentration and amount of acid can be adjusted according to actual needs. As long as the pH is between 1 and 5, the sol-gel reaction can be performed.

In some embodiments, the solvent used in the above sol-gel reaction may include methanol, ethanol, propanol, isopropanol, n-butanol, isobutanol, methyl ethyl ketone, acetone, cyclohexanone, methyl ethyl ketone, methyl t-butyl ketone, ethyl ether, ethylene glycol dimethyl ether, ethylene glycol ether, ethylene glycol monoethyl ether, tetrahydrofuran (THF), ethyl acetate, propylene glycol monomethyl ether acetate (PGMEA), ethyl-2-ethoxyethanol acetate, ethyl 3-ethoxypropionate, isoamyl acetate, n-butyl acetate, chloroform, pentane, n-hexane, cyclohexane, heptane, benzene, toluene, xylene, water, or a combination thereof.

In another embodiment of the present disclosure, a weather resistant coating is provided. The weather resistant coating includes 100 parts by weight of the aforementioned pigment composite particle 10, 500-1500 parts by weight of a resin, and 100-600 parts by weight of a solvent. In the present disclosure, the ratio of the components of the weather resistant coating may be adjusted according to needs to obtain a weather resistant coating having the desired properties. For example, in one embodiment, 100 parts by weight of the pigment composite particle 10, 500-1000 parts by weight of a resin, and 100-600 parts by weight of a solvent may be used to form the weather resistant coating. Alternatively, in another embodiment, a weather resistant paint may be formed using 100 parts by weight of the aforementioned pigment composite particle 10, 800-1500 parts by weight of a resin, and 100-600 parts by weight of a solvent.

In some embodiments, for example, 500-1000 parts by weight or 1000-1500 parts by weight of resin may be used relative to 100 parts by weight of the aforementioned pigment composite particle 10. In some embodiments, the resin used in the present disclosure may include acrylic resin, polyester resin, fluorocarbon resin, polyamine resin, polyimine resin, polyether resin, epoxy resin, urethane resin, polystyrene resin (PS resin), polyvinyl butyral resin (PVB resin), silicone resin, phenoxy resin, urea resin, acrylonitrile-butadiene-styrene resin (ABS resin), or a combination thereof.

In some embodiments, for example, 100-400 parts by weight or 400-600 parts by weight of a solvent may be used relative to 100 parts by weight of the aforementioned pigment composite particle 10. In some embodiments, the solvent used in the disclosure may include methanol, ethanol, propanol, isopropanol, n-butanol, isobutanol, methyl ethyl ketone, acetone, cyclohexanone, methyl ethyl ketone, methyl t-butyl ketone, ethyl ether, ethylene glycol dimethyl ether, ethylene glycol ether, ethylene glycol monoethyl ether, tetrahydrofuran (THF), ethyl acetate, propylene glycol monomethyl ether acetate (PGMEA), ethyl-2-ethoxyethanol acetate, ethyl 3-ethoxypropionate, isoamyl acetate, n-butyl acetate, chloroform, pentane, n-hexane, cyclohexane, heptane, benzene, toluene, xylene, water, or a combination thereof.

In some embodiments, the weather resistant coating provided by the present disclosure may further include a dispersant. In some embodiments, the dispersant may be a polymeric dispersant, for example, an ethylene vinyl acetate copolymer, an ethylene vinyl acetate copolymer mixture, an ethylene acrylic acid copolymer, a polyamide/polyethylene oxide copolymer mixture, a polyethylene copolymer, or a combinations thereof.

In some embodiments, the weather resistant coating provided by the present disclosure may further include other additives such as a toner. In some embodiments, the toner may be, for example, copper(II) phthalocyanine

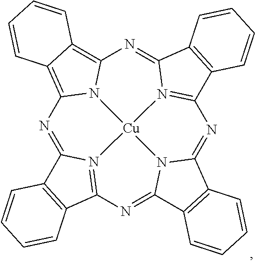

1-methyl-2-pyrrolidone, or a combination thereof. In the present disclosure, the color of the organic pigment may be adjusted to be close to black by adding a toner.

FIG. 2 is a schematic cross-sectional view illustrating a weather resistant structure according to an embodiment of the present disclosure. As shown in FIG. 2, in one embodiment of the present disclosure, a weather resistant structure 20 is provided which includes a substrate 22 and a weather resistant coating layer 24 on the substrate 22.

In some embodiments, the substrate 22 may include stainless steel, carbon steel, galvanized steel, galvanized aluminum, aluminum, cement, calcium silicate, tile, stone, fabric, or a combination thereof.

In some embodiments, the weather resistant coating layer 24 includes 100 parts by weight of the pigment composite particles 26 (equivalent to the pigment composite particles 10 in FIG. 1) and 500-1500 parts by weight of the resin 28. The pigment composite particles 26 are dispersed in the resin 28.

In some embodiments, for example, 500-1000 parts by weight or 1000-1500 parts by weight of the resin 28 may be used relative to 100 parts by weight of the pigment composite particles 26. In some embodiments, the resin 28 may include acrylic resin, polyester resin, fluorocarbon resin, polyamine resin, polyimine resin, polyether resin, epoxy resin, urethane resin, polystyrene resin (PS resin), polyvinyl butyral resin (PVB resin), silicone resin, phenoxy resin, urea resin, acrylonitrile-butadiene-styrene resin (ABS resin), or a combination thereof.

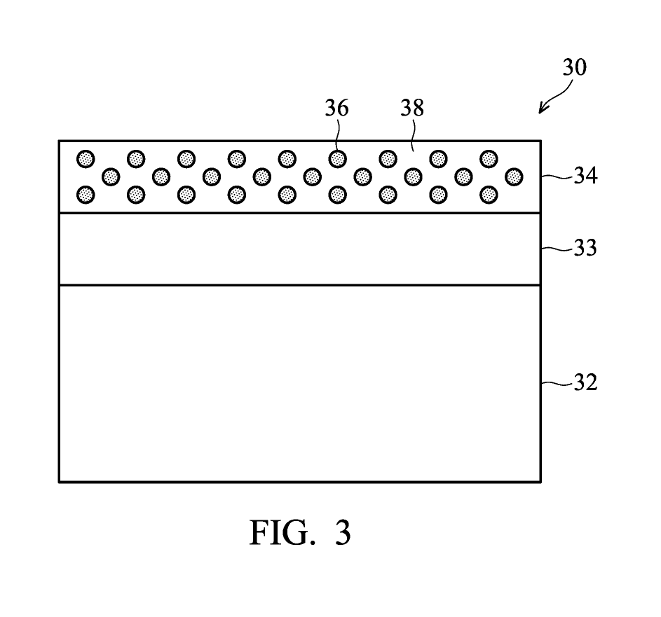

FIG. 3 is a schematic cross-sectional view illustrating a weather resistant structure according to another embodiment of the present disclosure. As shown in FIG. 3, similar to the weather resistant structure 20, the weather resistant structure 30 also includes a substrate 32, and a weather resistant coating layer 34 on the substrate 32.

In some embodiments, the substrate 32 may include stainless steel, carbon steel, galvanized steel, galvanized aluminum, aluminum, cement, calcium silicate, tile, stone, fabric, or a combination thereof.

In some embodiments, the weather resistant coating layer 34 includes 100 parts by weight of the pigment composite particles 36 (equivalent to the pigment composite particles 10 in FIG. 1) and 500-1500 parts by weight of the resin 38. The pigment composite particles 36 are dispersed in the resin 38.

In some embodiments, for example, 500-1000 parts by weight or 1000-1500 parts by weight of the resin 38 may be used relative to 100 parts by weight of the pigment composite particles 36. In some embodiments, the resin 38 may include acrylic resin, polyester resin, fluorocarbon resin, polyamine resin, polyimine resin, polyether resin, epoxy resin, urethane resin, polystyrene resin (PS resin), polyvinyl butyral resin (PVB resin), silicone resin, phenoxy resin, urea resin, acrylonitrile-butadiene-styrene resin (ABS resin), or a combination thereof.

The difference between the weather resistant structure 30 and the weather resistant structure 20 shown in FIG. 2 is that the weather resistant structure 30 further includes a reflective layer 33 disposed between the substrate 32 and the weather resistant coating layer 34. In some embodiments, the reflective layer 33 may be, for example, a coating layer having a high refractive index. In an embodiment, the coating layer having a high refractive index may be formed of a coating containing titanium dioxide (TiO₂).

The weather resistant structures 20, 30 provided by the present disclosure may be coated on the substrates 22, 32 or the reflective layer 33 by the aforementioned weather resistant coating and dried to form the weather resistant coating layers 24, 34. In some embodiments, the coating process may be, for example, spin coating, blade coating, bar coating, wire bar coating, brush coating, roller coating, spray coating, flow coating, other applicable coating processes, or a combination thereof.

In the embodiments of the present disclosure, the thickness of the weather resistant coating layers 24, 34 may be adjusted according to different applications to obtain weather resistant structures 20, 30 with desired properties. For example, in some embodiments, the weather resistant coating layers 24, 34 may have a thickness 20 μm-60 μm, such as 20 μm-40 μm or 40 μm-60 μm.

The pigment composite particles provided by the present disclosure and the coatings and structures formed thereof have high weather resistance. After environmental weather resistance tests, the ΔE of coating film after the ultraviolet light irradiation is less than or equal to 2, which solves the problem of poor weather resistance of organic pigments at present. For example, in some embodiments, ΔE of coating film is less than 1 or less than 0.5 after the ultraviolet light irradiation.

The Examples and Comparative Examples are described below to illustrate the pigment composite particle and the weather resistant coatings and weather resistant structures formed therefrom provided by the present disclosure and the properties thereof.

### COMPARATIVE EXAMPLE 1

0.3 g of organic pigment particles (BASF Paliogen L0086, the structure is shown below) was added to 3 g of isopropanol (IPA) and mixed evenly. Then, 0.24 g of 0.1N hydrochloric acid was added to prepare a dispersion solution containing organic pigment particles.

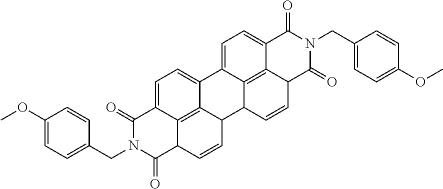

### EXAMPLE 1

0.6 g of tetraethoxysilane (TEOS) and 0.3 g of organic pigment particles (BASF Paliogen L0086) were added to 3 g of isopropanol (IPA) and mixed evenly. Then, 0.24 g of 0.1N hydrochloric acid was added. Next, after performing a sol-gel reaction at room temperature for about 2 hours, the temperature was raised to about 80° C., and the reaction was continued for 2 hours to prepare a dispersion solution containing pigment composite particles.

### EXAMPLE 2

The same process as described in Example 1 was repeated, except that tetraethoxynonane (TEOS) was replaced by methyltriethoxysilane (MTES). A dispersion solution containing pigment composite particles was prepared.

### EXAMPLE 3

The same process as described in Example 1 was repeated, except that 0.24 g of 0.1N hydrochloric acid was replaced by 0.24 g of 1N hydrochloric acid, and after the sol-gel reaction was performed at room temperature for about 2 hours, the temperature was raised to about 60° C., and the reaction was continued for 2 hours to prepare a dispersion solution containing pigment composite particles.

### EXAMPLE 4

The same process as described in Example 1 was repeated, except that the organic pigment particles were replaced by BASF Paliogen L0086: Red 224 with a weight ratio of about 10:4 and a small amount of copper phthalocyanine which was used as the toner. Also, 3 g of isopropyl (IPA) was replaced by 2.4 g of 1-butanol (NBA) and 0.6 g of ethyl acetate (EAC). The structure of Red 224 was shown as follows.

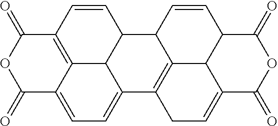 [SMILES: O=C1OC(=O)C2=C3C1=CC=C1C4=C5C(C=CC6C(=O)OC(=O)C(=CC4)C56)C(C=C2)C13]

### Preparation of Coating Layer and Structure

3 g of dispersion solution obtained in each Comparative example and each Example was mixed evenly with 7 g of acrylic resin (manufacturer: Changxing; model: 7132) to form a coating. Then, the coating was coated on an aluminum plate by a blade coating method and dried at 100° C. for 10 minutes to form a coating layer, thereby completing the structure. The structure prepared using the coating of each Comparative example and each Example has a coating layer with the same thickness.

The structures were subjected to an environmental weather resistant test using an ultraviolet weathering tester (QUV).

From the results of the tests, it was found that the ΔE of the weather resistant structures prepared in Examples 1, 3, and 4 after 1000 hours of the ultraviolet light irradiation was 0.72, 0.96, and 0.20, respectively. The ΔE of the weather resistant structure prepared in Example 2 after 750 hours of the ultraviolet light irradiation was 0.17. It reveals that the weather resistant structures prepared in Examples 1 to 4 had good weather resistance after the ultraviolet light irradiation. According to the ASTM G154 test standard, the service life of the above weather resistant structures can be as long as 5 years.

In contrast, the ΔE of weather resistant structure prepared in Comparative Example 1 after 1000 hours of the ultraviolet light irradiation was 2.1, indicating that the weather resistance was not good.

From the above results, it can be seen that the pigment composite particles provided by the present disclosure can be made into weather resistant coatings and weather resistant structures having high weather resistance. The ΔE of the weather resistant structures after the ultraviolet light irradiation can be less than or equal to 2 (e.g. less than 1 or less than 0.5). The weather resistant coatings and weather resistant structures can be widely used in construction, exterior walls, roofs, cars, or fabrics.

It will be apparent to those skilled in the art that various modifications and variations can be made to the disclosed embodiments. It is intended that the specification and examples be considered as exemplary only, with the true scope of the disclosure being indicated by the following claims and their equivalents.

What is claimed is:

1. A pigment composite particle, which is:
a covalently bonded product of a crosslinking structure having silicon-oxygen bonds and a plurality of organic pigment particles, and the plurality of organic pigment particles are dispersed in the crosslinking structure;
wherein the chemical structure of the organic pigment particles comprise C═O and one or more structures selected from a group consisting of: 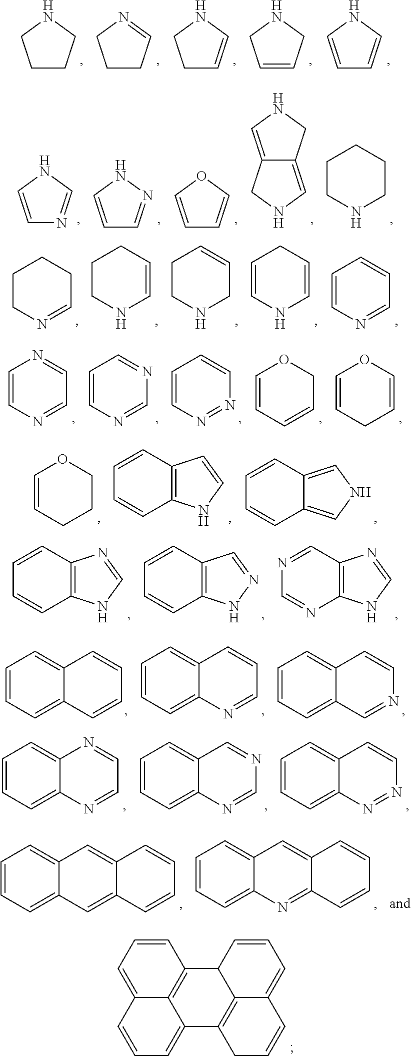
wherein the hydrogen atom on one or more carbons of the above groups is unsubstituted or substituted by halogen atom, CH₃, NH₂, or benzene ring.

2. The pigment composite particle as claimed in claim 1, wherein the organic pigment particles comprise: 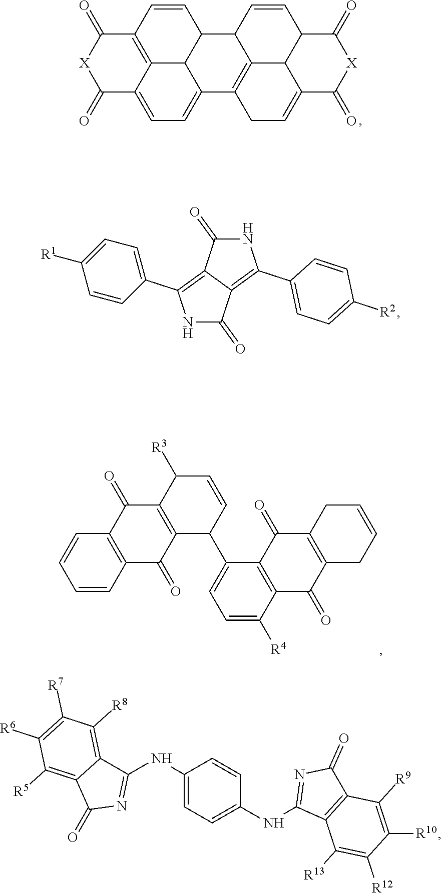
or a combination thereof, wherein X is O, NR, or a combination thereof, R¹ and R² are the same or different and each of R¹ and R² is independently NR, hydrogen atom, halogen atom, hydrocarbon group, benzene ring, or a combination thereof, R³ and R⁴ are the same or different and each of R³ and R⁴ is independently NR, hydrogen atom, halogen atom, hydrocarbon group, benzene ring, or a combination thereof, R⁵ to R¹³ are the same or different and each of R⁵ to R¹³ is independently NR, hydrogen atom, halogen atom, hydrocarbon group, benzene ring, or a combination thereof, wherein R is hydrogen atom, benzene ring, hydrocarbon group, alkylphenyl, or alkylphenyl substituted by alkoxy.

3. The pigment composite particle as claimed in claim 1, wherein the organic pigment particles comprise: 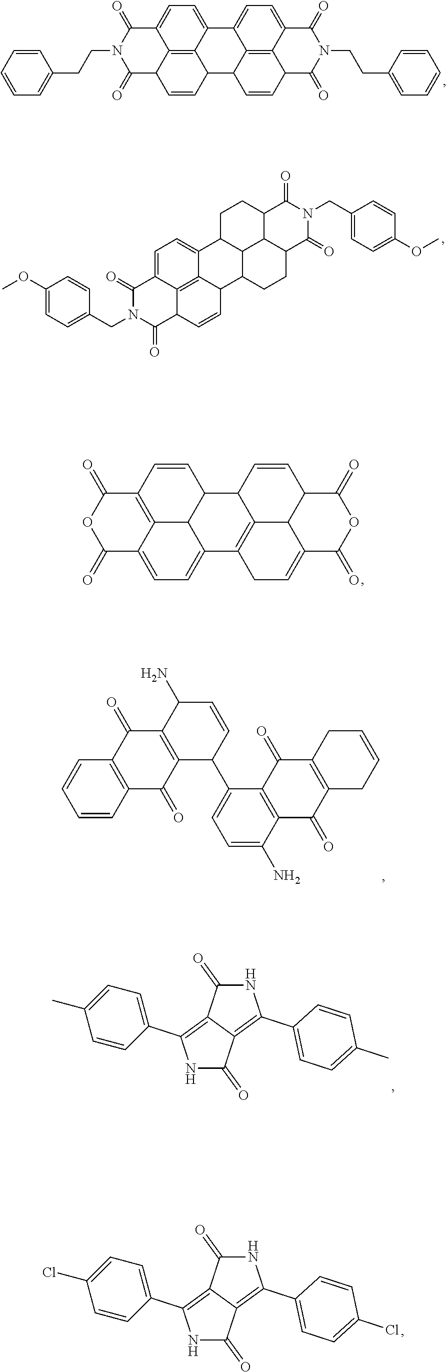 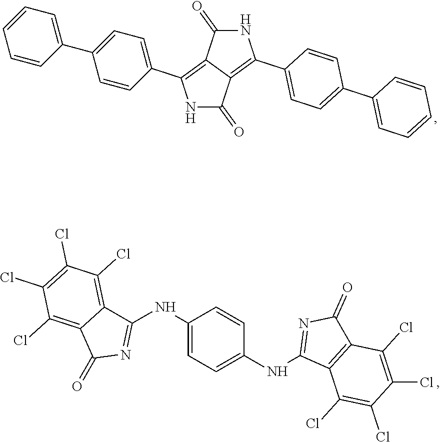 [SMILES: O=C1NC(c2ccc(-c3ccccc3)cc2)=C2C(=O)NC(c3ccc(-c4ccccc4)cc3)=C12 ; O=C1N=C(Nc2ccc(NC3=NC(=O)c4c(Cl)c(Cl)c(Cl)c(Cl)c43)cc2)c2c(Cl)c(Cl)c(Cl)c(Cl)c21]
or a combination thereof.

4. The pigment composite particle as claimed in claim 1, wherein the crosslinking structure having silicon-oxygen bonds is condensated by siloxane compounds having the formula of Si(OR¹)₄ or Si(OR²)₃R³, wherein each of R¹, R², and R³ is independently H or alkyl group.

5. The pigment composite particle as claimed in claim 4, wherein the siloxane compounds comprise tetramethoxysilane (TMOS), tetraethoxysilane (TEOS), tetrabutyl orthosilicate (TBOS), methyltriethoxysilane (MTES), n-propyltriethoxysilane, triethoxypentylsilane, isobutyltriethoxysilane, n-octyltriethoxysilane, or a combination thereof.

6. The pigment composite particle as claimed in claim 1, wherein the weight ratio of the crosslinking structure having silicon-oxygen bonds and the organic pigment particles is 1:1-3:1.

7. A weather resistant coating, comprising:
100 parts by weight of the pigment composite particle as claimed in claim 1;
500-1500 parts by weight of a resin; and
100-600 parts by weight of a solvent.

8. The weather resistant coating as claimed in claim 7, wherein the resin comprises acrylic resin, polyester resin, fluorocarbon resin, polyamine resin, polyimine resin, polyether resin, epoxy resin, urethane resin, polystyrene resin (PS resin), polyvinyl butyral resin (PVB resin), silicone resin, phenoxy resin, urea resin, acrylonitrile-butadiene-styrene resin (ABS resin), or a combination thereof.

9. The weather resistant coating as claimed in claim 7, wherein the solvent comprises methanol, ethanol, propanol, isopropanol, n-butanol, isobutanol, methyl ethyl ketone, acetone, cyclohexanone, methyl ethyl ketone, methyl t-butyl ketone, ethyl ether, ethylene glycol dimethyl ether, ethylene glycol ether, ethylene glycol monoethyl ether, tetrahydrofuran (THF), ethyl acetate, propylene glycol monomethyl ether acetate (PGMEA), ethyl-2-ethoxyethanol acetate, ethyl 3-ethoxypropionate, isoamyl acetate, n-butyl acetate, chloroform, pentane, n-hexane, cyclohexane, heptane, benzene, toluene, xylene, water, or a combination thereof.

10. A weather resistant structure, comprising:
a substrate; and
a weather resistant coating layer, disposed on the substrate, wherein the weather resistant coating layer comprises: 100 parts by weight of the pigment composite particle as claimed in claim 1 and 500-1500 parts by weight of a resin.

11. The weather resistant structure as claimed in claim 10, wherein the substrate comprises stainless steel, carbon steel, galvanized steel, galvanized aluminum, aluminum, cement, calcium silicate, tile, stone, fabric, or a combination thereof.

12. The weather resistant structure as claimed in claim 10, wherein the resin comprises acrylic resin, polyester resin, fluorocarbon resin, polyamine resin, polyimine resin, polyether resin, epoxy resin, urethane resin, polystyrene resin (PS resin), polyvinyl butyral resin (PVB resin), silicone resin, phenoxy resin, urea resin, acrylonitrile-butadiene-styrene resin (ABS resin), or a combination thereof.

13. The weather resistant structure as claimed in claim 10, wherein the thickness of the weather resistant coating layer is 20 μm-60 μm.

14. The weather resistant structure as claimed in claim 10, wherein the weather resistant structure further comprises a reflective layer, disposed between the substrate and the weather resistant coating layer.

15. The weather resistant structure as claimed in claim 14, wherein the reflective layer is a coating layer with high reflectance.
